(19) United States
(12) Patent Application Publication
(10) Pub. No.: US 2016/0071317 A1
(43) Pub. Date: Mar. 10, 2016

(54) GRAPHICS PROCESSING UNIT (GPU) INCLUDING SUBDIVIDER AND DEVICE INCLUDING THE GPU

(71) Applicant: Samsung Electronics Co., Ltd., Suwon-si (KR)

(72) Inventors: Seok Hoon KIM, Yongin-si (KR); Chang Hyo YU, Yongin-si (KR)

(21) Appl. No.: 14/813,089

(22) Filed: Jul. 29, 2015

(30) Foreign Application Priority Data
Sep. 10, 2014 (KR) 10-2014-0119629

(51) Int. Cl. G06T 17/20

(52) U.S. Cl. CPC G06T 17/20

(57) ABSTRACT

A graphics processing unit (GPU) includes a subdivider connected between a vertex shader and a domain shader. The subdivider receives first points of a first patch from the vertex shader, computes and assigns a tessellation factor for the first patch, generates second patches by refining the first patch using the first points and the tessellation factor, determines whether each of the second patches satisfies a tessellation criterion, and feeds back a patch that does not satisfy the tessellation criterion among the second patches to an input of the subdivider as a first feedback patch.

### CROSS-REFERENCE TO RELATED APPLICATIONS

This application claims priority under 35 U.S.C. §119(a) from Korean Patent Application No. 10-2014-0119629 filed on Sep. 10, 2014, the disclosure of which is hereby incorporated by reference in its entirety.

### BACKGROUND

Embodiments disclosed herein relate to graphics processing, and more particularly, to a graphics processing unit (GPU) including a subdivider that refines a patch and provides feedback until tessellation criteria are satisfied, and a device including the GPU.

Surface tessellation is a computer-graphics technique for making curved lines or surfaces smoother using an increased number of triangles by refining a mesh of polygons or a patch representing a surface equation. To implement tessellation, two methods are used: a method of tessellating a parametric surface; and a method of tessellating a subdivision surface. When tessellating a parametric surface, a tessellation factor determining how finely a mesh is split, or refined, is set before the start of the tessellation. Nevertheless, the tessellation factor cannot be dynamically changed during the tessellation of the parametric surface. As a result, a mesh can become more finely subdivided or less finely subdivided than necessary.

### SUMMARY

Some embodiments disclosed herein provide a graphics processing unit comprising a subdivider, which refines patches until tessellation criteria are satisfied and feeds back at least one patch that does not satisfy the tessellation criteria among the tessellated patches, and a device comprising the graphics processing unit.

According to some embodiments, there is provided a graphics processing unit (GPU) comprising a subdivider connected between a vertex shader and a domain shader. The subdivider receives a plurality of first points associated with a first patch from the vertex shader, computes and assigns a tessellation factor to the first patch, generates a plurality of second patches by refining the first patch using the first points and the tessellation factor, determines whether each of the plurality of second patches satisfies a tessellation criterion, and feeds back to an input of the subdivider a patch of the plurality of second patches that does not satisfy the tessellation criterion as a first feedback patch.

The subdivider may compute and assign a new tessellation factor to the first feedback patch, generate a plurality of third patches by refining the first feedback patch using a plurality of second points associated with the first feedback patch and the new tessellation factor, determine whether each of the plurality of third patches satisfies the tessellation criterion, and feed back to the input of the subdivider a patch of the plurality of third patches that does not satisfy the tessellation criterion as a second feedback patch.

The subdivider may transmit to the domain shader a patch of the plurality of second patches that satisfies the tessellation criterion as a passing patch.

The tessellation criterion may comprise a depth, a curvature, or non-geometry information. Each of the first and second patches may comprise either a parametric surface patch or a subdivision surface patch.

The subdivider may assign the tessellation factor to one of the plurality of first first points. As an alternative, the subdivider may assign the tessellation factor to one of a plurality of edges included in the first patch. As another alternative, the subdivider may assign the tessellation factor to a face defined by the first patch.

According to other embodiments, there is provided a system on chip (SoC) including a GPU including a subdivider connected between a vertex shader and a domain shader, a central processing unit (CPU) configured to control an operation of the GPU, and a memory accessed by the GPU and the CPU. The subdivider receives a plurality of first points of a first patch from the vertex shader, computes and assigns a tessellation factor to the first patch, generates a plurality of second patches by refining the first patch using the plurality of first points and the tessellation factor, determines whether each of the plurality of second patches satisfies a tessellation criterion, feeds back to an input of the subdivider a patch of the plurality of second patches that does not satisfy the tessellation criterion as a first feedback patch, and transmits to the domain shader a patch of the plurality of second patches that satisfies the tessellation criterion as a first passing patch.

The subdivider may compute and assign a new tessellation factor to the first feedback patch, generate a plurality of third patches by refining the first feedback patch using a plurality of second points associated with the first feedback patch and the new tessellation factor, determine whether each of the plurality of third patches satisfies the tessellation criterion, feed back to the input of the subdivider a patch of the plurality of second patches that does not satisfy the tessellation criterion as a second feedback patch, and transmit to the domain shader a patch of the plurality of third patches that satisfies the tessellation criterion as a second passing patch.

If the tessellation criterion comprises a depth and a depth of the first feedback patch is less than the depth of the tessellation criterion, the subdivider may feed back the first feedback patch to its input. If the tessellation criterion comprises a curvature and a curvature of the first feedback patch is greater than the curvature of the tessellation criterion, the subdivider may feed back the first feedback patch to its input. If the tessellation criterion comprises a brightness and a brightness of the first feedback patch is greater than the brightness of the tessellation criterion, the subdivider may feed back the first feedback patch to its input.

The subdivider may assign the tessellation factor to one of the plurality of first points, one of a plurality of edges included in the first patch, or a face defined by the first patch.

According to still other embodiments, there is provided a computing device comprising a GPU comprising a subdivider connected between a vertex shader and a domain shader, a memory controller configured to transmit a first patch from a memory to the GPU, and a CPU configured to control an operation of the GPU. The subdivider receives a plurality of first points of a first patch from the vertex shader, computes and assigns a tessellation factor to the first patch, generates a plurality of second patches by refining the first patch using the first points and the tessellation factor, determines whether each of the plurality of second patches satisfies a tessellation criterion, feeds back to an input of the subdivider a patch of the plurality of second patches that does not satisfy the tessellation criterion as a first feedback patch, and transmits to the domain shader a patch of the plurality of second patches that satisfies the tessellation criterion as a first passing patch.

The subdivider may compute and assign a new tessellation factor to the first feedback patch, generate a plurality of third patches by refining the first feedback patch using a plurality of second points associated with the first feedback patch and the new tessellation factor, determine whether each of the plurality of third patches satisfies the tessellation criterion, feed back to an input of the subdivider a patch of the plurality of third patches that does not satisfy the tessellation criterion as a second feedback patch, and transmit to the domain shader a patch of the plurality of third patches that satisfies the tessellation criterion as a second passing patch.

According to further embodiments, there is provided a GPU comprising a subdivider connected between a vertex shader and a domain shader. The subdivider receives a plurality of first points of a first patch from the vertex shader, determines whether the first patch satisfies a tessellation criterion, computes and assigns a tessellation factor to the first patch if the first patch does not satisfy the tessellation criterion, generates a plurality of second patches by refining the first patch using the plurality of first points and the tessellation factor, determines whether each of the plurality of second patches satisfies the tessellation criterion, feeds back to an input of the subdivider a patch of the plurality of the second patches that does not satisfy the tessellation criterion as first feedback patches and transmits to the domain shader a patch of the plurality of second patches that satisfies the tessellation criterion as a passing patch.

The subdivider may compute and assign a new tessellation factor to a processed patch that does not satisfy the tessellation criterion among the first feedback patches, generate a plurality of third patches by refining the processed patch using a plurality of second points associated with the processed patch and the new tessellation factor, and feed back to the input of the subdivider a patch of the plurality of third patches as second feedback patches.

According to some embodiments, there is provided a system, comprising an input interface, and output interface and a subdivider. The input interface is configured to receive an input patch representing a surface equation. The subdivider is coupled to the input interface, and the subdivider configured to: (a) assign at least one tessellation factor to the input patch, (b) subdivide the input patch to form a plurality of subdivided patches based on the at least one tessellation factor, and (c) determine whether each subdivided patch satisfies a tessellation criterion. If a subdivided patch does not satisfy the tessellation criterion, the subdivider is configured to define the subdivided patch as an input patch and repeating (a)-(c), and if a subdivided patch satisfies the tessellation criterion, the subdivider is configured to output the subdivided patch to the output interface.

In some exemplary embodiments, the input patch comprises a plurality of points, in which case, the subdivider is further configured to assign a tessellation factor to each of the plurality of points.

In some exemplary embodiments, the input patch is received by the interface from a vertex shader.

In some exemplary embodiments, the tessellation criterion comprises a depth, a curvature, or non-geometry information.

In some exemplary embodiments, the input patch comprises a parametric surface patch or a subdivision surface patch.

In some exemplary embodiments, the input patch comprises a plurality of edges, in which case the subdivider is further configured to assign a tessellation factor to each of the plurality of edges.

In some exemplary embodiments, the subdivider is further configured to assign the at least one tessellation factor to a face defined by the input patch.

In some exemplary embodiments, the system comprises part of a graphics processing unit pipeline. In some exemplary embodiments, the graphics processing pipeline comprises part of an electronic device comprising a touch screen display.

According to some embodiments, there is provides a method comprising: (a) assigning at least one tessellation factor to an input patch, the input patch representing a surface equation; (b) subdividing the input patch to form a plurality of subdivided patches based on the at least one tessellation factor; and (c) determining whether each subdivided patch satisfies a tessellation criterion. If a subdivided patch satisfies the tessellation criterion, outputting the subdivided patch to a domain shader; and if a subdivided patch does not satisfy the tessellation criterion, defining the subdivided patch as an input patch and repeating (a)-(c).

In some exemplary embodiments, the input patch comprises a plurality of points, in which case the at least one tessellation factor to the input patch comprises assigning a tessellation factor to each of the plurality of points.

In some exemplary embodiments, the input patch is received from a vertex shader.

In some exemplary embodiments, the tessellation criterion comprises a depth, a curvature, or non-geometry information.

In some exemplary embodiments, the input patch comprises a parametric surface patch or a subdivision surface patch.

In some exemplary embodiments, the input patch comprises a plurality of edges, in which case assigning the at least one tessellation factor to the input patch comprises assigning a tessellation factor to each of the plurality of edges.

In some exemplary embodiments, assigning the at least one tessellation factor to the input patch comprises assigning the at least one tessellation factor to a face defined by the input patch.

In some exemplary embodiments, the method comprises part of a graphics processing unit pipeline.

According to some embodiments, there is provides an article of manufacture comprising: a non-transitory computer-readable medium having stored thereon instructions that, if executed, result in at least the following: (a) assigning at least one tessellation factor to an input patch, the input patch representing a surface equation; (b) subdividing the input patch to form a plurality of subdivided patches based on the at least one tessellation factor; and (c) determining whether each subdivided patch satisfies a tessellation criterion. If a subdivided patch satisfies the tessellation criterion, outputting the subdivided patch to a domain shader; and if a subdivided patch does not satisfy the tessellation criterion, defining the subdivided patch as an input patch and repeating (a)-(c).

In some exemplary embodiments, the input patch comprises a plurality of points, in which case the instructions stored thereon the computer-readable medium, if executed, further result in assigning the at least one tessellation factor to the input patch comprises assigning a tessellation factor to each of the plurality of points.

In some exemplary embodiments, the input patch is received from a vertex shader.

In some exemplary embodiments, the tessellation criterion comprises a depth, a curvature, or non-geometry information.

In some exemplary embodiments, the input patch comprises a parametric surface patch or a subdivision surface patch.

In some exemplary embodiments, the input patch comprises a plurality of edges, in which case the instructions stored thereon the computer-readable medium, if executed, further result in assigning the at least one tessellation factor to the input patch comprises assigning a tessellation factor to each of the plurality of edges.

In some exemplary embodiments, the instructions stored thereon the computer-readable medium, if executed, further result in assigning the at least one tessellation factor to the input patch comprises assigning the at least one tessellation factor to a face defined by the input patch.

In some exemplary embodiments, the instructions stored thereon the computer-readable medium comprise part of a graphics processing unit pipeline.

### BRIEF DESCRIPTION OF THE DRAWINGS

The above and other features and advantages of the subject matter disclosed herein will become more apparent by describing in detail exemplary embodiments thereof with reference to the attached drawings in which:

FIG. 1 is a block diagram of a computing device according to some embodiments disclosed herein;

FIG. 2 is a detailed block diagram of a central processing unit (CPU) and a graphics processing unit (GPU) illustrated in FIG. 1;

FIG. 3 is a diagram of a pipeline of the GPU illustrated in FIG. 1 according to some embodiments disclosed herein;

FIG. 4 is a conceptual diagram of an operation of a subdivider according to some embodiments disclosed herein;

FIG. 5 is a flowchart of a method of operating a subdivider according to some embodiments disclosed herein;

FIG. 6 is a flowchart of a method of operating a subdivider according to other embodiments disclosed herein;

FIG. 7 is a flowchart of a method of operating a subdivider according to still other embodiments disclosed herein;

FIG. 8 is a flowchart of a method of operating a subdivider according to further embodiments disclosed herein;

FIGS. 9A to 9C ate conceptual diagrams of procedures for calculating and assigning a tessellation factor for each point according to some embodiments disclosed herein;

FIGS. 10A to 10G are conceptual diagrams of refinement and comparison performed by a subdivider according to some embodiments disclosed herein;

FIG. 11 is a conceptual diagram of a procedure for assigning a tessellation factor for each point and generating a new point according to some embodiments disclosed herein; and

FIG. 12 depicts an exemplary embodiment of an article of manufacture comprising a non-transitory computer-readable storage medium having stored thereon computer-readable instructions that, when executed by a computer-type device, results in any of the various techniques and methods according to the subject matter disclosed herein.

### DETAILED DESCRIPTION OF THE EMBODIMENTS

Embodiments of a graphics processing unit (GPU) comprising a subdivider are described herein with reference to the accompanying drawings. According to the subject matter disclosed herein, a subdivider refines a patch and provides feedback until one or more tessellation criterion is satisfied, and a device including the GPU. The subject matter disclosed herein may, however, be embodied in many different forms and should not be construed as limited to the embodiments set forth herein. Rather, these embodiments are provided so that this disclosure will be thorough and complete, and will fully convey the scope of the claimed subject matter to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the subject matter disclosed herein belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

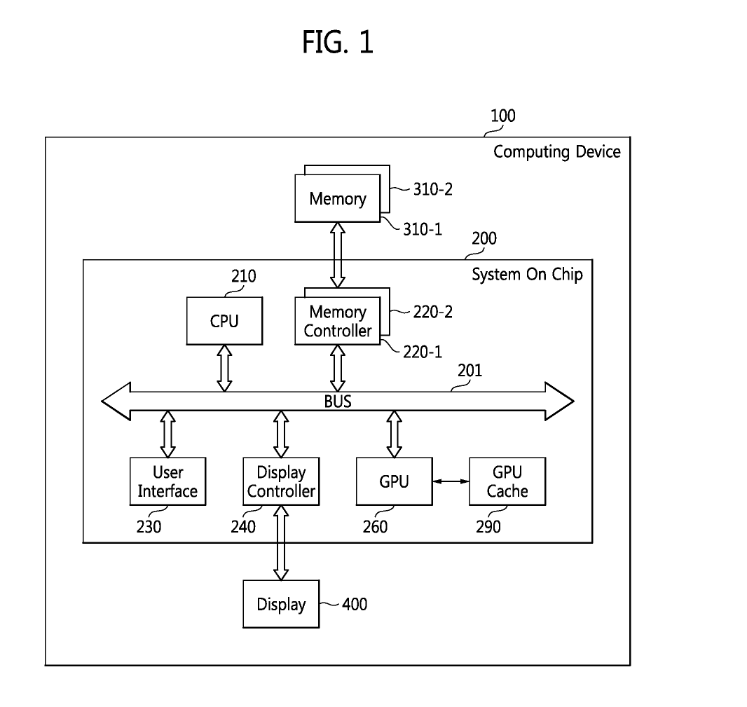

FIG. 1 is a block diagram of a computing device 100 according to some embodiments disclosed herein. The computing device 100 may be implemented as a television (TV), a digital TV (DTV), an internet protocol TV (IPTV), a personal computer (PC), a desktop computer, a laptop computer, a computer workstation, a tablet PC, a video game platform (or a video game console), a server, or a portable electronic device. The portable electronic device may be a cellular phone, a smart phone, a personal digital assistant (PDA), an enterprise digital assistant (EDA), a digital still camera, a digital video camera, a portable multimedia player (PMP), a personal navigation device or portable navigation device

(PND), a mobile internet device (MID), a wearable computer, an Internet-of-Things (IoT) device, an Internet-of-Everything (IoE) device, or an e-book.

The computing device 100 may include various types of data processing devices that can process two-dimensional (2D) or three-dimensional (3D) graphics data and display the processed data on a display 400. The computing device 100 may include a System on a Chip (SoC) 200, at least one memory 310-1 and 310-2, and the display 400. The at least one memory 310-1 and 310-2 may be included in the SoC 200.

The SoC 200 may function as a host. The SoC 200 may control the overall operation of the computing device 100. For example, the SoC 200 may be replaced with an integrated circuit (IC), a printed circuit board (PCB), a mother board, an application processor (AP), or a mobile AP, which can perform operations described hereinafter in the embodiments disclosed herein.

A central processing unit (CPU) 210, at least one memory controller 220-1 and 220-2, a user interface 230, a display controller 240, and a graphics processing unit (GPU) 260 communicate with one another through a bus 201. For example, the bus 201 may be implemented as a peripheral component interconnect (PCI) bus, a PCI express bus, an advanced microcontroller bus architecture (AMBA), an advanced high-performance bus (AHB), an advanced peripheral bus (APB), an advanced extensible interface (AXI), or a combination thereof.

The CPU 210 may control the operation of the SoC 200. The CPU 210 may include one or more cores. A user may enter an input into the SoC 200 through the user interface 230 so that the CPU 210 executes at least one application (e.g., a software application). The at least one application executed by the CPU 210 may include an operating system (OS), a word processor application, a media player application, a video game application, and/or a graphical user interface (GUI) application.

A user may enter an input into the SoC 200 through an input device (not shown) connected to the user interface 230. For example, the input device may be implemented as a keyboard, a computer mouse, a microphone, or a touch pad (or a touch screen) generating a touch input. Applications executed by the CPU 210 may include graphics rendering instructions, which may be related with a graphics application programming interface (API). A graphics API may be an open graphics library (OpenGL®) API, an open graphics library for embedded systems (Open GL ES) API, a DirectX API, a Renderscript API, a WebGL an API, or an Open VG(R) API.

To process graphics rendering instructions, the CPU 210 may transmit a graphics rendering command to the GPU 260 through the bus 201. The GPU 260 may process (or render) graphics data in response to the graphics rendering command.

The graphics data may include points, lines, triangles, quadrilaterals, patches, and/or primitives. The graphics data may also include line segments, elliptical arcs, quadratic Bezier curves, and/or cubic Bezier curves.

The at least one memory controller 220-1 and 220-2 may read data (e.g., graphics data) from the at least one memory 310-1 and 310-2 in response to a read request output from the CPU 210 or the GPU 260 and may transmit the data (e.g., the graphics data) to a corresponding element (e.g., 210, 240, or 260). The at least one memory controller 220-1 and 220-2 may write data (e.g., graphics data) output from a corresponding element (e.g., 210, 230, or 240) to the at least one memory 310-1 and 310-2 in response to a write request output from the CPU 210 or the GPU 260.

The at least one memory controller 220-1 and 220-2 is separate from the CPU 210 or the GPU 260 in the embodiments illustrated in FIG. 1, but the at least one memory controller 220-1 and 220-2 may be formed within the CPU 210, the GPU 260, or the at least one memory 310-1 and 310-2. When the first memory 310-1 is formed with volatile memory and the second memory 310-2 is formed with non-volatile memory, the first memory controller 220-1 may be implemented to be able to communicate with the first memory 310-1 and the second memory controller 220-2 may be implemented to be able to communicate with the second memory 310-2.

The volatile memory may be random access memory (RAM), static RAM (SRAM), dynamic RAM (DRAM), synchronous DRAM (SDRAM), thyristor RAM (T-RAM), zero capacitor RAM (Z-RAM), or twin transistor RAM (TTRAM). The non-volatile memory may be electrically erasable programmable read-only memory (EEPROM), flash memory, magnetic RAM (MRAM), spin-transfer torque MRAM, ferroelectric RAM (FeRAM), phase-change RAM (PRAM), or resistive RAM (RRAM). The non-volatile memory may also be implemented as a multimedia card (MMC), an embedded MMC (eMMC), a universal flash storage (UFS), a solid-state drive (SSD), a universal serial bus (USB) flash drive, or a hard disk drive (HDD).

The at least one memory 310-1 and 310-2 may store a program (or an application) or instructions, which can be executed by the CPU 210. In addition, the at least one memory 310-1 and 310-2 may store data to be used by a program executed by the CPU 210. The at least one memory 310-1 and 310-2 may also store a user application and graphics data related with the user application and may store data (or information) to be used or generated by components included in the SoC 200.

The at least one memory 310-1 and 310-2 may store data used for and/or generated by the operation of the GPU 260. The at least one memory 310-1 and 310-2 may store command streams for the process of the GPU 260.

The display controller 240 may transmit data processed by the CPU 210 or data (e.g., graphics data) processed by the GPU 260 to the display 400. The display 400 may be implemented as a monitor, a TV monitor, a projection device, a thin film transistor-liquid crystal display (TFT-LCD), a light emitting diode (LED) display, an organic LED (OLED) display, an active-matrix OLED (AMOLED) display, or a flexible display.

The display 400 may be included in the computing device 100. The display 400 may be a screen of a portable electronic device or a stand-alone device connected to the computing device 100 through a wireless or wired communication link. Alternatively, the display 400 may be a computer monitor connected to a PC through a cable or a wired link.

The GPU 260 may receive commands output from the CPU 210 and execute the commands. Commands executed by the GPU 260 may include a graphics command, a memory transfer command, a kernel execution command, a tessellation command for controlling a tessellation factor, and/or a texturing command. The GPU 260 may perform graphics operations for rendering graphics data.

When an application executed by the CPU 210 requests graphics processing, the CPU 210 may transmit the graphics data and a graphics command to the GPU 260 so that the graphics data is rendered in the display 400. The graphics command may include a tessellation command for controlling a tessellation factor or a texturing command. The graphics data may include vertex data, texture data, or surface data. Here, a surface may be a parametric surface, a subdivision surface, a triangle mesh, or a curve.

The CPU 210 may transmit a graphics command and graphics data to the GPU 260 in some embodiments. In other embodiments, when the CPU 210 writes a graphics command and graphics data to the at least one memory 310-1 and 310-2, the GPU 260 may read the graphics command and the graphics data from the at least one memory 310-1 and 310-2.

The GPU 260 may directly access a GPU cache 290. Accordingly, the GPU 260 may write or read graphics data to or from the GPU cache 290 without using the bus 201. The GPU 260 and the GPU cache 290 are shown separated from each other in the embodiments illustrated in FIG. 1, but the GPU 260 may include the GPU cache 290 in other embodiments. The GPU cache 290 may be formed with DRAM or SRAM. The CPU 210 or the GPU 260 may store processed (or rendered) graphics data in a frame buffer included in the at least one memory 310-1 and 310-2.

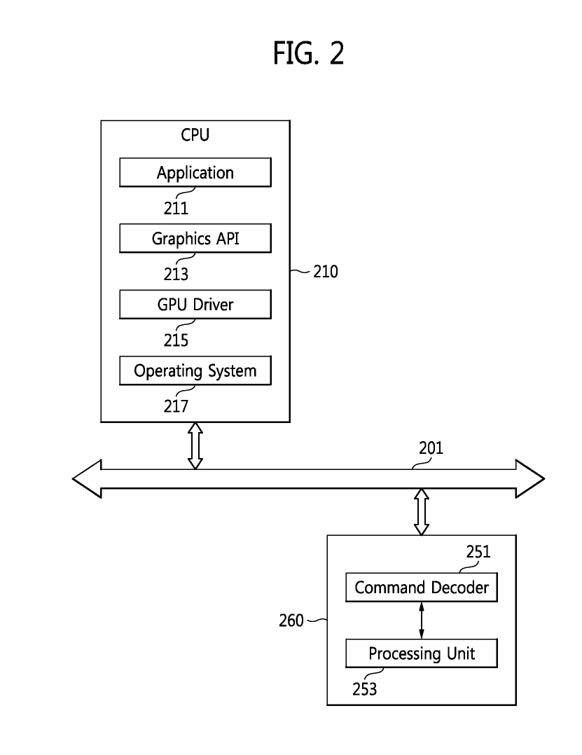

FIG. 2 is a detailed block diagram of the CPU 210 and the GPU 260 illustrated in FIG. 1. Referring to FIGS. 1 and 2, the CPU 210 and the GPU 260 may communicate with each other via the bus 201.

The CPU 210 and the GPU 260 may be integrated into a mother board or a SoC, or may be implemented in a graphics card installed at a mother board. The CPU 210 may include an application (e.g., a software application) 211, a graphics API 213, a GPU driver 215, and an OS 217. The CPU 210 may run or execute the components 211, 213, 215, and 217.

The application 211 may include instructions for displaying graphics data and/or instructions to be executed in the GPU 260. The application 211 may output the instructions to the graphics API 213. The graphics API 213 may convert the instructions received from the application 211 into a format used by the GPU driver 215.

The GPU driver 215 may receive the instructions through the graphics API 213 and may control the operation of the GPU 260 so that the instructions are carried out by the GPU 260. The GPU driver 215 may transmit commands to the GPU 260 through the OS 217 or may transmit the commands to the at least one memory 310-1 and 310-2 that can be accessed by the GPU 260.

The GPU 260 may include a command decoder (or a command engine) 251 and one or more processing units 253. The command decoder 251 may receive a command output from the CPU 210 or a command received through the at least one memory 310-1 and 310-2 and may control the GPU 260 to execute the command. The processing unit 253 may be a programmable processing unit or a fixed-function processing unit.

For example, a programmable processing unit may be a programmable shader unit that can execute at least one shader program. The programmable shader unit may be downloaded from the CPU 210 to the GPU 260. Programmable shader units executed by the processing units 253 may include a vertex shader unit, a hull shader unit, a domain shader unit, a geometry shader unit, a pixel shader unit (or fragment shader unit), and/or a unified shader unit.

A fixed-function processing unit may include hardware. The hardware is hard-wired to perform certain functions. For example, the fixed-function processing unit as the processing units 253 may include processing units that perform raster operations.

For example, the processing units 253 may form a 3D graphics pipeline. For example, the 3D graphics pipeline may comply with OpenGL®) API, Open GL ES API, DirectX API, Renderscript API, WebGL API, or Open VG(R) API.

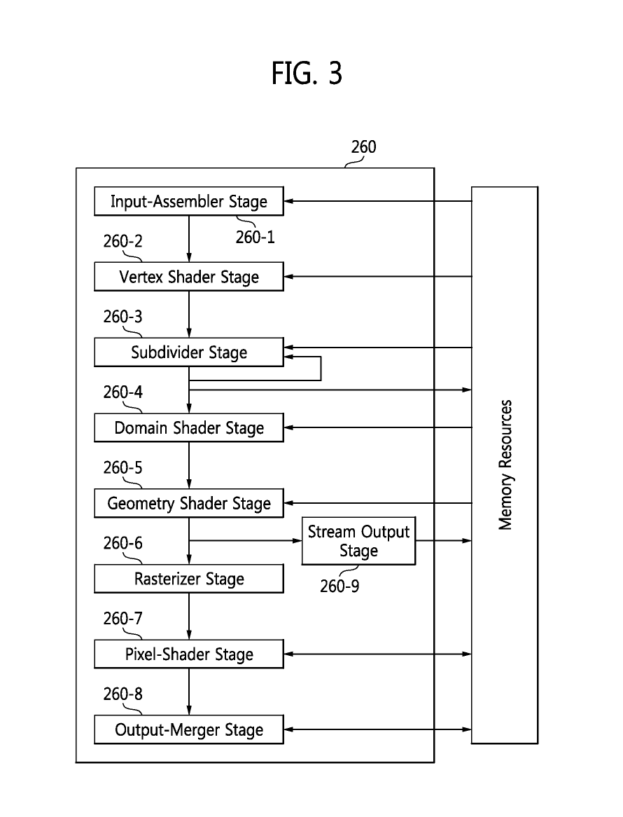

FIG. 3 is a diagram of a pipeline of the GPU 260 illustrated in FIG. 1 according to some embodiments disclosed herein. Apart from a subdivider 260-3, the pipeline may correspond to a graphics pipeline in Microsoft ® DirectX 11.

The graphics pipeline includes an input assembler 260-1, a vertex shader 260-2, the subdivider 260-3, a domain shader 260-4, a geometry shader 260-5, a rasterizer 260-6, a pixel shader 260-7, an output merger 260-8, and a stream output 260-9. Each of the components 260-1 through 260-9 may be referred to as a stage. The pixel shader 260-7 may be referred to as a fragment shader.

The subdivider 260-3 according to some embodiments disclosed herein may refine an input patch until the input patch satisfies predetermined criteria. The subdivider 260-3 includes the functions of a hull shader (not shown) and tessellator (not shown), and refinement and comparison functions which will be described in detail below.

The subdivider 260-3 and the domain shader 260-4 may form tessellation stages of the graphics pipeline. The tessellation stages may perform tessellation or a tessellation operation. For example, the input assembler 260-1, the rasterizer 260-6, and the output merger 260-8 may comprise fixed-function stages. The vertex shader 260-2, the subdivider 260-3, the domain shader 260-4, the geometry shader 260-5, and the pixel shader 260-7 may comprise programmable stages.

Each of the programmable stages comprises a structure in which a particular kind of shader program can be run. For example, the vertex shader 260-2 may run or execute a vertex shader program, the subdivider 260-3 may run a subdivider program, the domain shader 260-4 may run a domain shader program, the geometry shader 260-5 may run a geometry shader program, and the pixel shader 260-7 may run a pixel shader program. For example, each shader program may be executed in a shader unit of the GPU 260 at an appropriate timing.

Different kinds of shader programs may be executed in a common shader (or a common shader unit) of the GPU 260. For example, the common shader may be a unified shader. In other embodiments, at least one dedicated shader may exclusively run at least one particular kind of shader program.

The input assembler 260-1, the vertex shader 260-2, the subdivider 260-3, the domain shader 260-4, the geometry shader 260-5, pixel shader 260-7, and the output merger 260-8 may communicate data with memory resource(s). Accordingly, the input assembler 260-1, the vertex shader 260-2, the subdivider 260-3, the domain shader 260-4, the geometry shader 260-5, pixel shader 260-7, and the output merger 260-8 may retrieve or receive input data from the memory resource(s). The memory resource(s) may include at least one of the memories 290, 310-1, and 310-2.

The geometry shader 260-5 and the output merger 260-8 may write output data to the memory resource(s). The communication between the components 260-1 through 260-9 and the memory resource(s) illustrated in FIG. 3 is just an example and may be modified in various ways.

The input assembler 260-1 may acquire a plurality of vertices from a vertex buffer (not shown) of at least one memory and may process the vertices. As an alternative, the input assembler 260-1 may directly transmit a plurality of vertices to be processed to the vertex shader 260-2. As another alternative, the input assembler 260-1 may instruct the vertex shader 260-2 to retrieve a plurality of vertices to be processed from the vertex buffer.

The vertex shader 260-2 may receive a plurality of vertices from the input assembler 260-1 and/or a plurality of vertices from the memory resources and process the vertices to generate output vertices with respect to the respective processed vertices. The vertices input to the vertex shader 260-2 are referred to as input points and the output vertices generated from the vertex shader 260-2 are referred to as output points.

The vertex shader 260-2 may generate at least one output attribute with respect to an output vertex. A vertex input to the vertex shader 260-2 may include at least one input attribute. Output attributes may not be the same as input attributes. For example, the vertex shader 260-2 may generate output attributes by adding new attributes to or subtracting new attributes from input attributes. The input attributes may include vertex information (e.g., coordinate information, normal vector, texture information, and/or color information).

The output attributes may include geometry information and non-geometry information. Geometry information may be depth values or curvatures of output points of the vertex shader 260-2. Non-geometry information may be brightness values of output points, brightness values of patches, brightness values of primitives, or brightness values of frames. Non-geometry information may also include shade information.

Apart from the stage 260-3 reflecting unique technical ideas of the subject matter disclosed herein, the functions and operations of the remaining stages 260-1, 260-2, and 260-4 through 260-9 are substantially the same as or similar to those of corresponding stages included in a graphics pipeline defined in Microsoft® DirectX 11.

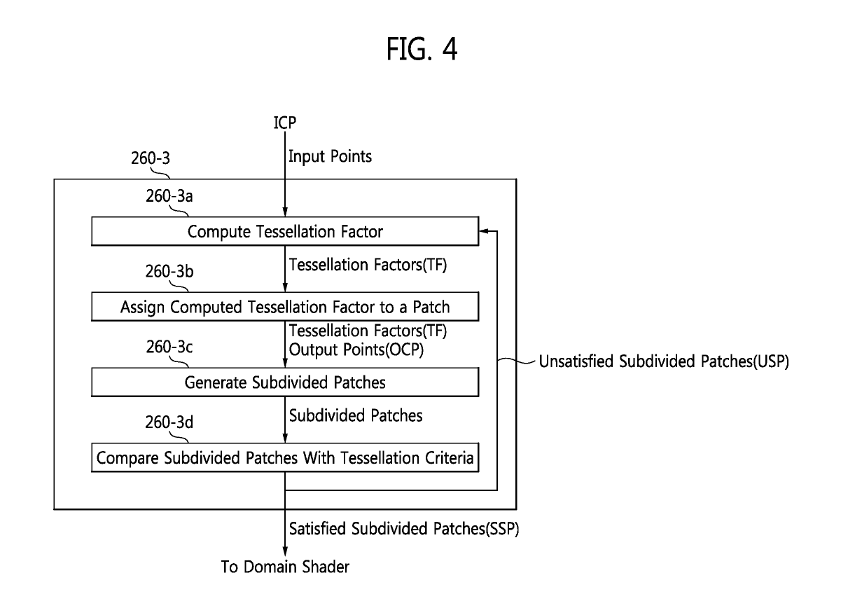

FIG. 4 is a conceptual diagram of an operation of the subdivider 260-3 according to some embodiments disclosed herein. Referring to FIGS. 3 and 4, the subdivider 260-3 receives output points, i.e., points ICP of an input patch from the vertex shader 260-2. The subdivider 260-3 may compute at least one tessellation factor TF to be assigned to the input patch in operation 260-3a.

The tessellation factor TF may be an integer or a decimal fraction. The tessellation factor TF may be computed in the subdivider 260-3 using various algorithms. One of the algorithms may be a depth-comparison algorithm. For example, according to user-defined criteria or user-defined algorithm, a tessellation factor for a point close to virtual eyes of a user may be set to a large value and a tessellation factor for a point far from the virtual eyes may be set a small value. Another one of the algorithms may be a curvature-comparison algorithm. A curvature may be computed using various methods. The at least one tessellation factor TF computed by the subdivider 260-3 may be assigned to the input patch in operation 260-3b. The assigning may be performed during tessellation in which a surface is tessellated.

The surface includes a parametric surface, a subdivision surface, a triangle mesh, or a curve. An appearance of a realistic 3D object may be represented using the surface.

The tessellation factor TF may be assigned to a point of the input patch. As an alternative, the tessellation factor TF may be assigned to an edge of the input patch. As another alternative, the tessellation factor TF may be assigned to a face defined by the input patch.

The subdivider 260-3 may include a patch equation used in the tessellation pipeline 260. For example, the patch equation may be a curve equation or a surface equation. The curve equation may be a Hermite curve equation, a Bezier curve equation, a

NURBS curve equation, or a B-spline curve equation. Values related with the patch equation may be coefficients of the patch equation. Detailed descriptions of the patch equation will be omitted.

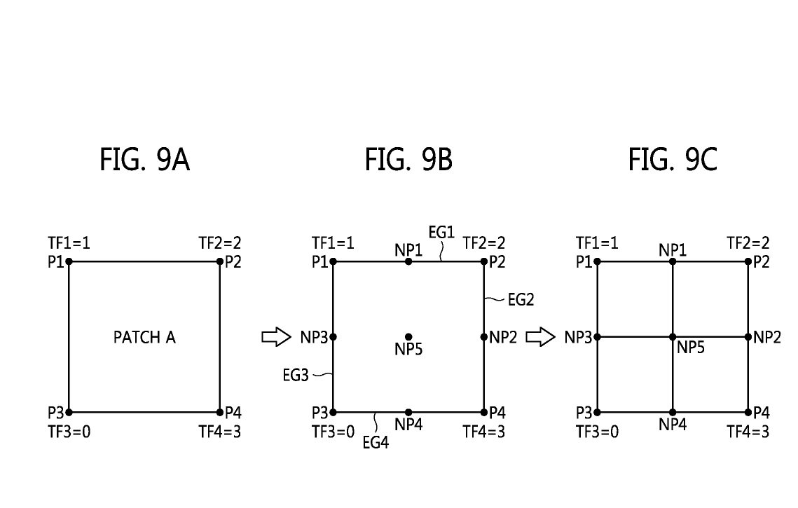

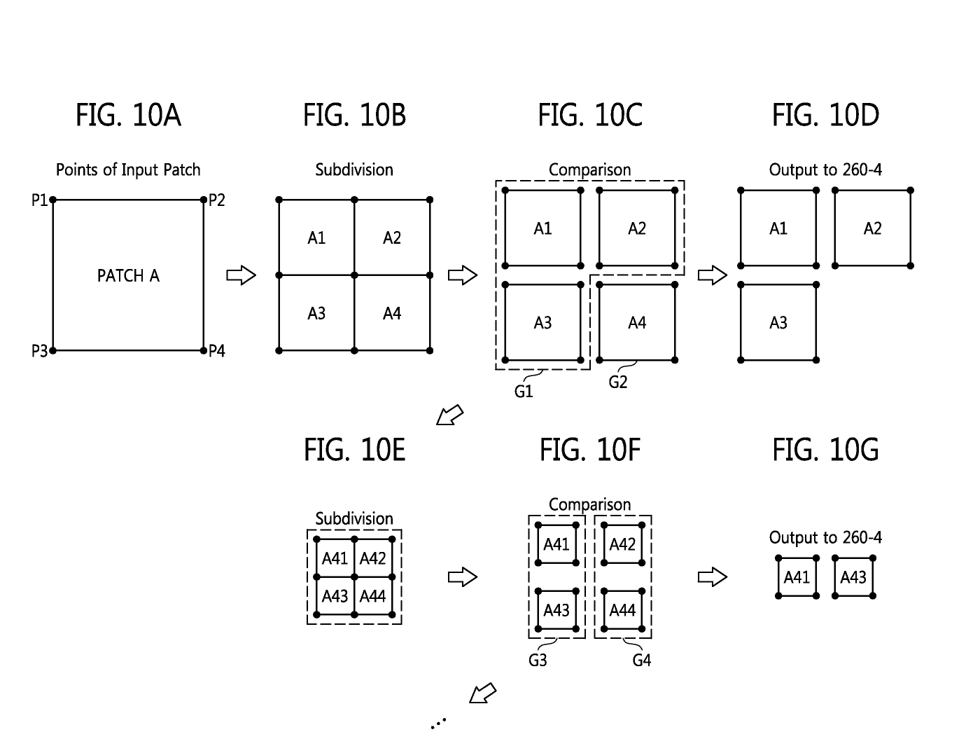

The subdivider 260-3 refines the input patch using the points of the input patch and tessellation factors TF assigned to the input patch, thereby generating subdivided patches in operation 260-3c. For example, when each of the tessellation factors TF is assigned to each of the points of the input patch, the subdivider 260-3 may generate new point(s) corresponding to each tessellation factor TF assigned to each point of the input patch and may generate a plurality of patches using the new point(s) and the input patch. Refinement of the input patch will be described in detail with reference to FIGS. 9 and 10.

The subdivider 260-3 compares each of the subdivided patches with a tessellation criterion to select patches satisfying the tessellation criterion among the subdivided patches in operation 260-3d. For example, the tessellation criterion may be depth, curvature, or non-geometry information. The subdivider 260-3 may select at least one patch having a depth value less than a depth criterion (or reference depth value) among the subdivided patches as an unsatisfied subdivided patch USP and may select at least one patch having a depth value equal to or greater than the depth criterion as a satisfied subdivided patch SSP.

As an alternative, the subdivider 260-3 may select at least one patch having a curvature value greater than a curvature criterion (or a reference curvature value) among the subdivided patches as the unsatisfied subdivided patch USP and may select at least one patch having a curvature value equal to or less than the curvature criterion as the satisfied subdivided patch SSP.

As another alternative, the subdivider 260-3 may select at least one patch having a brightness value greater than a brightness criterion (or reference brightness value) among the subdivided patches as the unsatisfied subdivided patch USP and may select at least one patch having a brightness value equal to or less than the brightness criterion as the satisfied subdivided patch SSP.

The subdivider 260-3 transmits at least one satisfied subdivided patch SSP to the domain shader 260-4 and feeds back at least one unsatisfied subdivided patch USP to an input of the subdivider 260-3. For example, when all of the subdivided patches satisfy the tessellation criterion, the subdivided patches may all be transmitted to the domain shader 260-4. When only some of the subdivided patches satisfy the tessellation criterion, the some of the subdivided patches may only be transmitted to the domain shader 260-4. When any of the subdivided patches does not satisfy the tessellation criterion, all of the subdivided patches may be fed back to the input of the subdivider 260-3.

As shown in FIG. 4, the subdivider 260-3 computes a tessellation factor with respect to the at least one unsatisfied subdivided patch USP that has been fed back in operation 260-3a, assigns the tessellation factor for the at least one unsatisfied subdivided patch USP in operation 260-3b, generates at least one new subdivided patch using the tessellation factor and at least one point of the unsatisfied subdivided patch USP in operation 260-3c, and compares the new subdivided patch with the tessellation criterion in operation 260-3d.

Until the subdivided patch(es) satisfy the tessellation criterion, at least one unsatisfied subdivided patch USP is fed back to the input of the subdivider 260-3. For example, the subdivider 260-3 may set a maximum iteration number of feedback of an unsatisfied subdivided patch USP.

When the number of times at least one unsatisfied subdivided patch USP has been fed back is greater than the maximum iteration number, the subdivider 260-3 may directly transmit the unsatisfied subdivided patch USP to the domain shader 260-4.

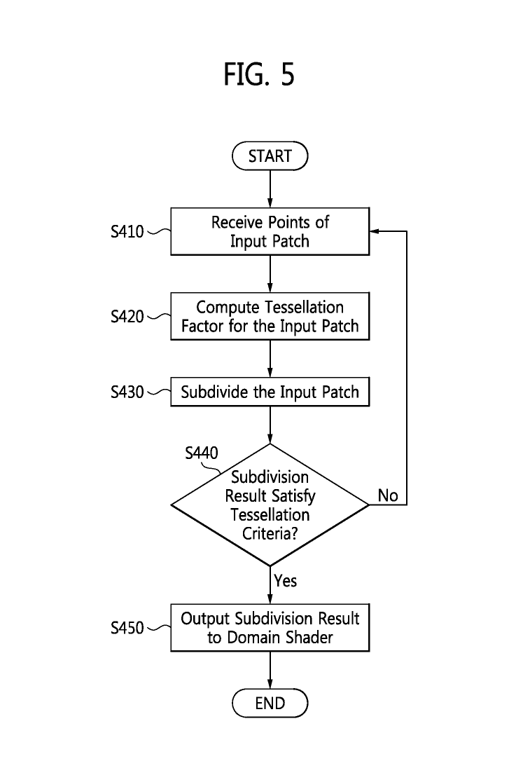

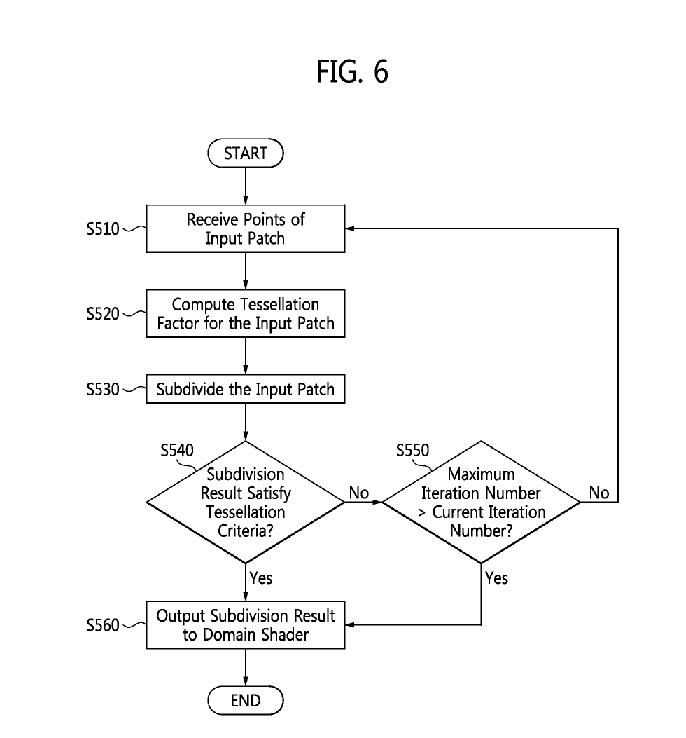

FIG. 5 is a flowchart of a method of operating the subdivider 260-3 according to some embodiments disclosed herein. FIG. 6 is a flowchart of a method of operating the subdivider 260-3 according to other embodiments disclosed herein. Referring to FIGS. 5 and 6, the subdivider 260-3 may receive points of an input patch from the vertex shader 260-2 in operations S410 and S510. For example, an initial input of the subdivider 260-3 may be a patch input from the vertex shader 260-2, but subdivided patches may be input to the subdivider 260-3 during feedback.

The input patch may include both the input patch received from the vertex shader 260-2 and a patch input by the feedback. The subdivider 260-3 computes a tessellation factor to be assigned for the input patch in operations S420 and S520. For example, the subdivider 260-3 may compute a tessellation factor to be assigned to a point or an edge included in the input patch or to a face defined by the input patch. The tessellation factor may be an integer or a decimal fraction and may be computed using one of various algorithms, such as a curvature algorithm and a depth algorithm.

The subdivider 260-3 assigns the tessellation factor to the input patch (e.g., a point, an edge, or a face of the input patch) and subdivides the input patch in operations S430 and S530. Here, subdividing means to generate at least one new point using the tessellation factor assigned for the input patch and at least one point of the input patch and to generate a plurality of new patches. A procedure for dividing an input patch into new patches may be referred to as refinement.

The subdivider 260-3 compares the subdivision result (e.g., the new patches) with a tessellation criterion and determines whether the subdivision result satisfies the tessellation criterion in operations S440 and S540. As described above, the tessellation criterion may be geometry information (e.g., depth or curvature) or non-geometry information (e.g., brightness).

The subdivider 260-3 compares each of the new patches generated as the subdivision result with the tessellation criterion and feeds back at least one new patch that does not satisfy the tessellation criterion to the input of the subdivider 260-3 or transmits at least one new patch that satisfies the tessellation criterion to the domain shader 260-4 in operations S450 and S560. For example, the subdivider 260-3 may feed back a new patch that does not satisfy the tessellation criterion to the input of the subdivider 260-3 and perform refinement on the new patch until all new patches satisfy the tessellation criterion.

Referring to FIG. 6, the subdivider 260-3 counts a current iteration number of feedback (hereinafter, referred to as a feedback number) of a new patch that does not satisfy the tessellation criterion and compares the feedback number with the maximum iteration number in operation S550.

When the feedback number is equal to or less than the maximum iteration number, the subdivider 260-3 feeds back at least one new patch that does not satisfy the tessellation criterion to its input. If the feedback number is, however, greater than the maximum iteration number, the subdivider 260-3 transmits at least one new patch that does not satisfy the tessellation criterion to the domain shader 260-4 in operation S560. For example, when the maximum iteration number is set to 5, a patch resulting from sixth refinement is not fed back to the input of the subdivider 260-3, but is transmitted to the domain shader 260-4.

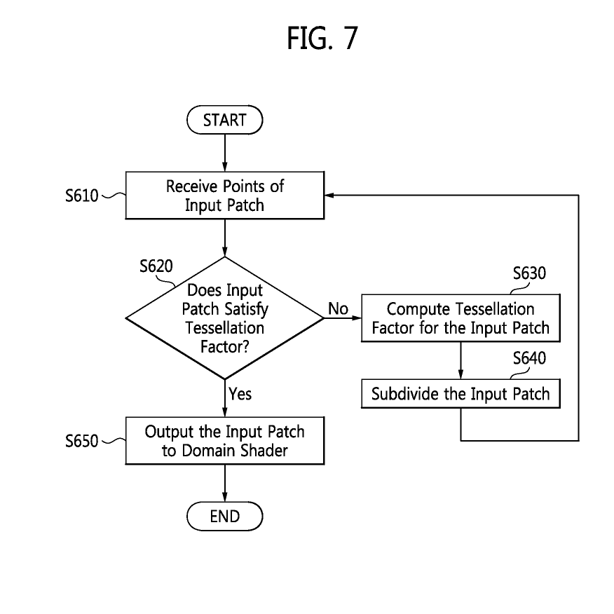

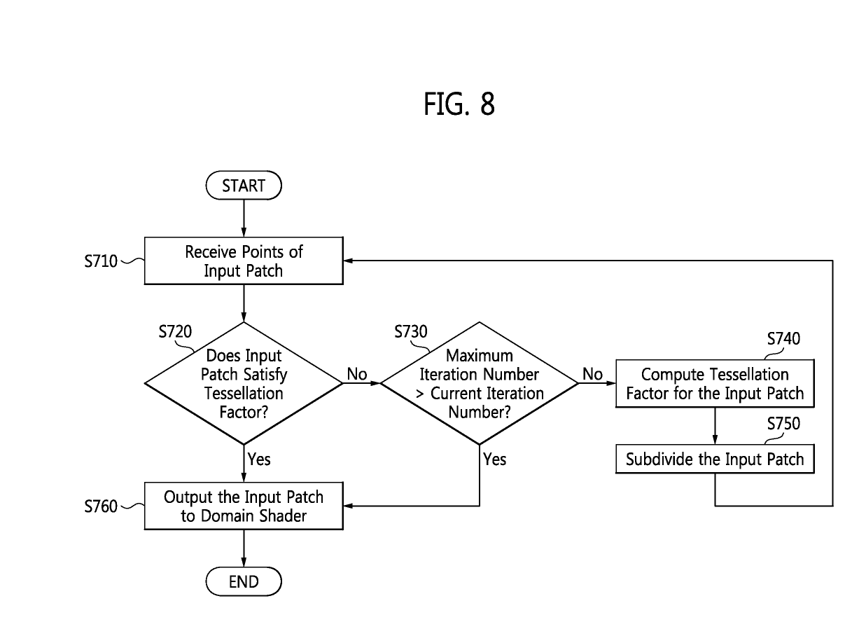

FIG. 7 is a flowchart of a method of operating the subdivider 260-3 according to still other embodiments disclosed herein. FIG. 8 is a flowchart of a method of operating the subdivider 260-3 according to further embodiments disclosed herein.

Referring to FIGS. 7 and 8, the subdivider 260-3 may receive points of an input patch from the vertex shader 260-2 in operations S610 and S710. For example, an initial input of the subdivider 260-3 may be a patch input from the vertex shader 260-2, but subdivided patches may be input to the subdivider 260-3 during feedback.

The subdivider 260-3 may compare the input patch with a tessellation criterion and determine whether the input patch satisfies the tessellation criterion in operations S620 and S720. When the input patch does not satisfy the tessellation criterion, the subdivider 260-3 may compute a tessellation factor to be assigned to the input patch in operations S630 and S740.

The subdivider 260-3 may compute a tessellation factor to be assigned to a point or an edge included in the input patch or to a face defined by the input patch. The tessellation factor may be an integer or a decimal fraction and may be computed using one of various algorithms such as a curvature algorithm and a depth algorithm.

The subdivider 260-3 may assign the tessellation factor to the input patch and subdivide the input patch in operations S640 and S750. Here, subdividing means to generate at least one new point using the tessellation factor assigned to the input patch and at least one point of the input patch and to generate a plurality of new patches. A procedure for dividing an input patch into new patches may be referred to as refinement.

The subdivider 260-3 may feed back at least one new patch generated as a result of dividing the input patch as its input. For example, the subdivider 260-3 may repeat refinement of an input until an input patch or at least one new patch that has been fed back satisfies the tessellation criterion. When the input patch satisfies the tessellation criterion, the subdivider 260-3 may transmit the input patch to the domain shader 260-4 in operations S650 and S760.

As described above with reference to FIGS. 7 and 8, when the input patch does not satisfy the tessellation criterion, the tessellation factor is calculated and assigned for the input patch and refinement is performed. The input patch is divided into new patches through the refinement and the refinements of each of the new patches are counted.

Referring to FIG. 8, the subdivider 260-3 counts a current iteration number of feedback (hereinafter, referred to as a feedback number) at each refinement and compares the feedback number with the maximum iteration number in operation S730.

When the feedback number is equal to or less than the maximum iteration number, the subdivider 260-3 may compute a tessellation factor for the new patch that does not satisfy the tessellation criterion. If the feedback number, however, is greater than the maximum iteration number, the subdivider 260-3 may transmit the new patch to the domain shader 260-4 even though the new patch does not satisfy the tessellation criterion. For example, when the maximum iteration number is set to 5, a patch resulting from sixth refinement is not fed back to the input of the subdivider 260-3 but is transmitted to the domain shader 260-4.

FIGS. 9A to 9C are conceptual diagrams of procedures for calculating and assigning a tessellation factor to each point according to some embodiments disclosed herein. Referring to FIG. 9A, a square is an example of an input patch PATCH A. The subdivider 260-3 may computes tessellation factors TF1, TF2, TF3, and TF4 for points P1, P2, P3, and P4 of input patch PATCH A using at least one of various algorithms and may assign the tessellation factors TF1, TF2, TF3, and TF4 to the points P1, P2, P3, and P4.

Alternatively, the subdivider 260-3 may receive the tessellation factors TF1, TF2, TF3, and TF4 for the points P1, P2, P3, and P4 from an outside resource, e.g., a memory, and may assign the tessellation factors TF1, TF2, TF3, and TF4 to the points P1, P2, P3, and P4.

As shown FIG. 9A, the subdivider 260-3 may assign the first tessellation factor TF1 (=1) to the first point P1, the second tessellation factor TF2 (=2) to the second point P2, the third tessellation factor TF3 (=0) to the third point P3, and the fourth tessellation factor TF4 (=3) to the fourth point P4.

Referring to FIG. 9B, the subdivider 260-3 may generate new points NP1, NP2, NP3, NP4, and NP5 with respect to the points P1, P2, P3, and P4 at neighbors of the points P1, P2, P3, and P4. On the basis of the first point P1, a neighbor may be the first point P1, an edge including the first point P1, or a face including the first point P1, but the claimed subject matter is not restricted to these examples.

When a tessellation factor having a particular value (e.g., an integer or a decimal fraction) other than zero is assigned to a certain point, the subdivider 260-3 may generate as many new points as the particular value or a different number of new points than the particular value according to a program installed in the subdivider 260-3.

For example, when a tessellation factor assigned to the certain point is N (in which N is a natural number of at least 2), the subdivider 260-3 may generate N new points, 2N new points, or (N−1) new points according to the program, but the claimed subject matter is not restricted to this example.

When the points P1, P2, P3, and P4 are included in a parametric surface patch, the subdivider 260-3 may generate tessellated domain point(s) corresponding to the tessellation factors TF1, TF2, TF3, and TF4 assigned to the points P1, P2, P3, and P4. When the points

P1, P2, P3, and P4 are included in a subdivision surface patch or a triangle mesh patch, the subdivider 260-3 may refine basic meshes using the tessellation factors TF1, TF2, TF3, and TF4 assigned to the points P1, P2, P3, and P4.

It is assumed that the subdivider 260-3 generates points in order of the first point P1, the second point P2, the third point P3, and the fourth point P4. The order, however, may be changed in other embodiments. For example, the subdivider 260-3 may generate the new point NP1 at the midpoint of a first edge EG1 and the new point NP3 at the midpoint of a third edge EG3 using the first tessellation factor TF1 (=1) assigned to the first point P1.

The subdivider 260-3 may generate a new point at the midpoint between the new point NP1 and the second point P2, the new point NP2 on a second edge EG2, or the new point NP5 on the face using the second tessellation factor TF2 (=2) assigned to the second point P2. For example, the subdivider 260-3 may generate two new points using the second tessellation factor TF2 (=2) assigned to the second point P2. At this time, the points NP1 and NP5 or NP2 and NP5 may be generated using the second tessellation factor TF2 (=2) assigned to the second point P2.

The subdivider 260-3 may generate three new points using the fourth tessellation factor TF4 (=3) assigned to the fourth point P4. For example, the points NP2, NP4, and NP5 may be generated using the fourth tessellation factor TF4 (=3) assigned to the fourth point P4.

As shown FIGS. 9B and 9C, the subdivider 260-3 may generate new point(s) at various position(s) using the tessellation factors TF1, TF2, TF3, and TF4 assigned to the points P1, P2, P3, and P4. Referring to FIG. 9C, when new point(s) are all generated at each of the edges EG1, EG2, EG3, and EG4, the subdivider 260-3 may generate connectivity information, i.e., topology information indicating connection relationship of the points P1 through P4 and/or the new points NP1 through NP5. As shown in FIGS. 9A to 9C, the subdivider 260-3 may divide an input patch PATCH A into four subdivided patches.

FIGS. 10A to 10G are conceptual diagrams of refinement and comparison performed by the subdivider 260-3 according to some embodiments disclosed herein. The subdivider 260-3 receives input patch PATCH A including points P1, P2, P3, and P4, as shown in FIG. 10A; and performs refinement, as described above with reference to FIGS. 9A to 9C, to generate four subdivision patches A1, A2, A3, and A4 from the input patch PATCH A, as shown in FIG. 10B.

The subdivider 260-3 compares each of the subdivision patches A1, A2, A3, and A4 with a tessellation criterion and determines a first group G1 that satisfies the tessellation criterion and a second group G2 that does not satisfy the tessellation criterion according to the comparison result, as shown in FIG. 10C.

The subdivider 260-3 transmits, as passing patches, the patches A1 through A3 included in the first group G1 that satisfies the tessellation criterion to the domain shader 260-4, as shown in FIG. 10D. The subdivider 260-3, however, feeds back, as a feedback patch, the patch A4 included in the second group G2 that does not satisfy the tessellation criterion to the input of the subdivider 260-3.

The subdivider 260-3 may perform refinement, as described above with reference to FIGS. 9A to 9C, to generate four subdivision patches A41, A42, A43, and A44 from the patch A4, as shown in FIG. 10E. The subdivider 260-3 may compare each of the subdivision patches A41, A42, A43, and A44 with the tessellation criterion and determine a third group G3 that satisfies the tessellation criterion and a fourth group G4 that does not satisfy the tessellation criterion according to the comparison result, as shown in FIG. 10F.

The subdivider 260-3 transmits, as passing patches, the patches A41 and A43 included in the third group G3 that satisfies the tessellation criterion to the domain shader 260-4, as shown in FIG. 10G. The subdivider 260-3, however, feeds back, as feedback patches, the patches A42 and A44 included in the fourth group G4 that does not satisfy the tessellation criterion to the input of the subdivider 260-3. The subdivider 260-3 performs refinement on at least one subdivision patch that has been fed back. When the maximum iteration number, however, is set in the subdivider 260-3, the subdivider 260-3 may transmit the patch to the domain shader 260-4 even if the patch does not satisfy the tessellation criterion.

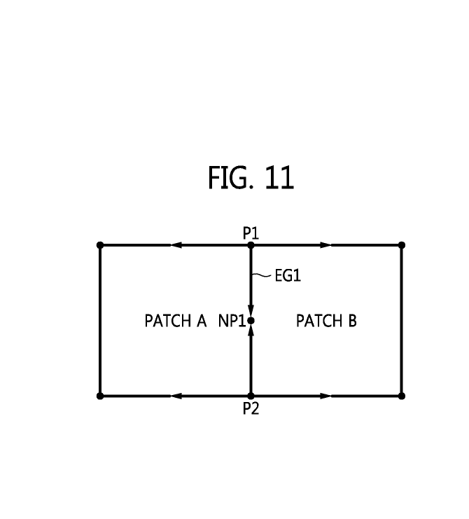

FIG. 11 is a conceptual diagram of a procedure for assigning a tessellation factor for each point and generating a new point according to some embodiments disclosed herein. Referring to FIG. 11, the subdivider 260-3 may compute and assign a tessellation factor to each of the points of the input patch to generate new points.

Patch PATCH A and patch PATCH B share an edge EG1 and point P1 and P2 with each other. The subdivider 260-3 may generate a new point NP1 from the point P1 to the point P2 in order to generate the new point NP1 at the midpoint of the edge EG1 including the points P1 and P2 of the patch PATCH A.

The subdivider 260-3 may generate the new point NP1 from the point P2 to the point P2 in order to generate the new point NP1 at the midpoint of the edge EG1 including the points P1 and P2 of the PATCH B. In other words, the new point NP1 generated from the patch PATCH A is at the same position as the new point NP1 generated from the patch PATCH B. Consequently, when a tessellation factor is assigned to each point and adjacent patches (i.e., patches PATCH A and PATCH B) share the edge EG1 with each other and the new point NP1 generated from the patch PATCH A is at the same position as the new point

NP1 generated from the patch PATCH B, a crack does not occur between the adjacent patches PATCH A and PATCH B.

As described above, according to some embodiments disclosed herein, in a GPU including a subdivider connected between a vertex shader and a domain shader, the subdivider replaces a hull shader and a tessellator, and can dynamically change a tessellation factor during tessellation or tessellation operation. Accordingly, the GPU can maintain or enhance visual quality and reduce unnecessary tessellation or tessellation operation.

The GPU repeats refinement of a patch until tessellation criteria are satisfied, thereby enhancing the quality of output images. The GPU assigns a tessellation factor to each point, thereby reducing an occurrence of a crack. Since a tessellation factor is assigned to each point, a patch is not influenced by adjacent patches, so that independent refinement can be performed on each patch.

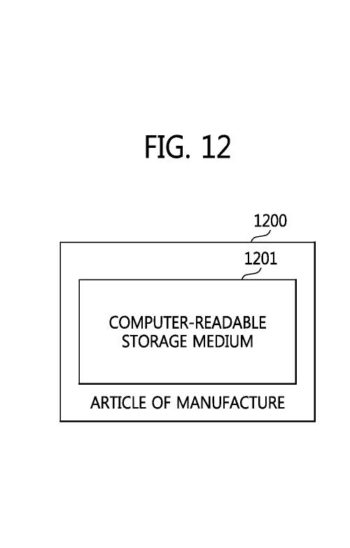

FIG. 12 depicts an exemplary embodiment of an article of manufacture 1200 comprising a non-transitory computer-readable storage medium 1201 having stored thereon computer-readable instructions that, when executed by a computer-type device, results in any of the various techniques and methods according to the subject matter disclosed herein. Exemplary computer-readable storage mediums that could be used for computer-readable storage medium 1201 could be, but are not limited to, a semiconductor-based memory, an optically based memory, a magnetic-based memory, or a combination thereof.

While the subject matter disclosed herein has been particularly shown and described with reference to exemplary embodiments thereof, it will be understood by those of ordinary skill in the art that various changes in forms and details may be made therein without departing from the spirit and scope of the subject matter disclosed herein as defined by the following claims.

1. A graphics processing unit (GPU), comprising:
a vertex shader;
a domain shader; and
a subdivider connected between the vertex shader and the domain shader,
the subdivider being configured to:
receive a plurality of first points associated with a first patch from the vertex shader,
compute and assign a tessellation factor to the first patch,
generate a plurality of second patches by refining the first patch using the first points and the tessellation factor,
determine whether each of the plurality of second patches satisfies a tessellation criterion, and
feed back to an input of the subdivider a patch of the plurality of second patches that does not satisfy the tessellation criterion as a first feedback patch.

2. The GPU of claim 1, wherein the subdivider is further configured to:
compute and assign a new tessellation factor to the first feedback patch,
generate a plurality of third patches by refining the first feedback patch using the plurality of second points and the new tessellation factor,
determine whether each of the plurality of third patches satisfies the tessellation criterion, and
feed back to the input of the subdivider a patch of the plurality of third patches that does not satisfy the tessellation criterion as a second feedback patch.

3. The GPU of claim 1, wherein the subdivider is further configured to:
transmit to the domain shader a patch of the plurality of second patches that satisfies the tessellation criterion as a passing patch.

4. The GPU of claim 1, wherein the tessellation criterion comprises a depth, a curvature, or non-geometry information.

5. The GPU of claim 1, wherein each of the plurality of first patches and the plurality of second patches comprises a parametric surface patch or a subdivision surface patch.

6. The GPU of claim 1, wherein the subdivider is further configured to assign the tessellation factor to a corresponding point of the plurality of first points.

7. The GPU of claim 1, wherein the subdivider is further configured to assign the tessellation factor to a corresponding edge of a plurality of edges included in the first patch.

8. The GPU of claim 1, wherein the subdivider is further configured to assign the tessellation factor to a face defined by the first patch.

9. A system on chip (SoC), comprising:
a graphics processing unit (GPU) comprising a subdivider connected between a vertex shader and a domain shader;
a central processing unit (CPU) configured to control an operation of the GPU; and
a memory accessed by the GPU and the CPU,
the subdivider being configured to:
receive a plurality of first points associated with a first patch from the vertex shader,
compute and assign a tessellation factor to the first patch,
generate a plurality of second patches by refining the first patch using the plurality of first points and the tessellation factor,
determine whether each of the plurality of second patches satisfies a tessellation criterion,
feed back to an input of the subdivider a patch of the plurality of second patches that does not satisfy the tessellation criterion as a first feedback patch, and
transmit to the domain shader a patch of the plurality of second patches that satisfies the tessellation criterion as a first passing patch.

10. The SoC of claim 9, wherein the subdivider is further configured to:
compute and assign a new tessellation factor to the first feedback patch,
generate a plurality of third patches by refining the first feedback patch using a plurality of second points associated with the first feedback patch and the new tessellation factor,
determine whether each of the plurality of third patches satisfies the tessellation criterion,
feed back to the input of the subdivider a patch of the plurality of third patches that does not satisfy the tessellation criterion as a second feedback patch, and
transmit to the domain shader a patch of the third plurality of patches that satisfies the tessellation criterion as a second passing patch.

11. The SoC of claim 9, wherein if the tessellation criterion comprises a depth and a depth of the first feedback patch is less than the depth of the tessellation criterion, the subdivider feeds back the first feedback patch to the input of the subdivider.

12. The SoC of claim 9, wherein if the tessellation criterion comprises a curvature and a curvature of the first feedback patch is greater than the curvature of the tessellation criterion, the subdivider feeds back the first feedback to the input of the subdivider.

13. The SoC of claim 9, wherein if the tessellation criterion comprises a brightness and a brightness of the first feedback patch is greater than the brightness of the tessellation criterion, the subdivider feeds back the first feedback patch to the input of the subdivider.

14. The SoC of claim 9, wherein the subdivider is further configured to assign the tessellation factor to one of the plurality of first points, one of a plurality of edges included in the first patch, or a face defined by the first patch.

15. A computing device, comprising:
a graphics processing unit (GPU) comprising a subdivider connected between a vertex shader and a domain shader;
a memory controller configured to transmit a first patch from a memory to the GPU; and
a central processing unit (CPU) configured to control an operation of the GPU,
the subdivider being configured to:
receive a plurality of first points associated with a first patch from the vertex shader,
compute and assign a tessellation factor to the first patch,
generate a plurality of second patches by refining the first patch using the plurality of first points and the tessellation factor,
determine whether each of the plurality of second patches satisfies a tessellation criterion,
feed back to an input of the subdivider a patch of the plurality of first patches that does not satisfy the tessellation criterion as a first feedback patch, and
transmit to the domain shader a patch of the plurality of second patches that satisfies the tessellation criterion as a first passing patch.

16. The computing device of claim 15, wherein the subdivider is further configured to:
compute and assign a new tessellation factor to the first feedback patch,
generate a plurality of third patches by refining the first feedback patch using a plurality of second points associated with the first feedback patch and the new tessellation factor,
determine whether each of the plurality of third patches satisfies the tessellation criterion,
feed back to the input of the subdivider a patch of the plurality of third patches that does not satisfy the tessellation criterion as a second feedback patch, and
transmit to the domain shader a patch of the plurality of third patches that satisfies the tessellation criterion as a second passing patch.

17. The computing device of claim 15, wherein if the tessellation criterion comprises a depth and a depth of the first feedback patch is less than the depth of the tessellation criterion, the subdivider feeds back the first feedback patch to the input of the subdivider.

18. The computing device of claim 15, wherein if the tessellation criterion comprises a curvature and a curvature of the first feedback patch is greater than the curvature of the tessellation criterion, the subdivider feeds back the first feedback patch to the input of the subdivider.

19. The computing device of claim 15, wherein if the tessellation criterion comprises a brightness and a brightness of the first feedback patch is greater than the brightness of the tessellation criterion, the subdivider feeds back the first feedback patch to the input of the subdivider.

20. The computing device of claim 15, wherein the subdivider is further configured to assign the tessellation factor to one of the plurality of first points, one of a plurality of edges associated with the first patch, or a face defined by the first patch.

21-22. (canceled)
